(19) United States
(12) Patent Application Publication
(10) Pub. No.: US 2008/0113329 A1
(43) Pub. Date: May 15, 2008

(54) COMPUTER-IMPLEMENTED METHODS, SYSTEMS, AND COMPUTER PROGRAM PRODUCTS FOR IMPLEMENTING A LESSONS LEARNED KNOWLEDGE MANAGEMENT SYSTEM

(75) Inventors: Lara Cumberland, Ridgefield, CT (US); Athena Taylor, White Salmon, WA (US); Douglas E. Ziemke, Southbury, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/559,103

(22) Filed: Nov. 13, 2006

(51) Int. Cl. G09B 7/00

(52) U.S. Cl. 434/362

(57) ABSTRACT

A computer-implemented method, system, and computer program product for implementing a lessons learned knowledge management system is provided. The computer-implemented method includes building a project database which, in turn, includes identifying project phases for a project, identifying categories for the project, and mapping each of the categories to respective phases of the project. The computer-implemented method further includes generating a workflow structure for the project, which includes assigning a reviewer to each of the categories, assigning an action owner to each of the categories, the action owner tasked with taking action on the lesson learned and defining a routing plan and timeline for transmittal of the lesson learned between the reviewer and the action owner. The computer-implemented method also includes processing lessons learned received for the project via the project database and the workflow structure.

### BACKGROUND OF THE INVENTION

The present disclosure relates generally to knowledge management and, in particular, to computer-implemented methods, systems, and computer program products for implementing an action-oriented lessons learned knowledge management system.

Knowledge management has been defined as a process for gathering and organizing information for subsequent use. A variety of types of knowledge management systems have been developed and are available for commercial use. For example, a knowledge management system may enable end users to gather information relating to a previously completed project that has similar characteristics to one that is currently underway or not yet started. This information may be used as a guide for project planners of the current project. During implementation of the project, various pitfalls or issues may become known and which require resolution. Resolving these issues may result in valuable lessons learned for the particular project team. A lesson learned may be defined as the knowledge acquired in response to implementation and subsequent analysis of a project. When conveyed to other parties, this knowledge may be useful in determining new and improved ways to implement future projects.

Lessons learned, by their nature, should be acted upon in some way to ensure that the lesson is mitigated to avoid having to learn it again in the future. While current knowledge bases in practice provide for the capture of information for future reference, there is currently no workflow management capability for these applications that would enable workflow management with respect to historical knowledge capture (e.g., lessons learned).

What is needed, therefore, is a way to capture and manage lessons learned for use in a knowledge management system.

### BRIEF SUMMARY OF THE INVENTION

Exemplary embodiments of the invention include a computer-implemented method, system, and computer program product for implementing a lessons learned knowledge management system is provided. The computer-implemented method includes building a project database which, in turn, includes identifying project phases for a project, identifying categories for the project, and mapping each of the categories to respective phases of the project. The computer-implemented method further includes generating a workflow structure for the project, which includes assigning a reviewer to each of the categories, assigning an action owner to each of the categories, the action owner tasked with talking action on the lesson learned and defining a routing plan and timeline for transmittal of the lesson learned between the reviewer and the action owner. The computer-implemented method also includes processing lessons learned received for the project via the project database and the workflow structure.

Other systems, methods, and computer program products according to embodiments will be or become apparent to one with skill in the art upon review of the following drawings and detailed description. It is intended that all such additional systems, methods, and computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram depicting a system upon which lesson management activities may be implemented in exemplary embodiments;

FIG. 2 is a flow diagram describing a process for building a project database and workflow structure used in implementing the lesson management activities in exemplary embodiments;

FIGS. 3A-3B are flow diagrams describing a process for implementing the lesson management activities via the project database and workflow structure in exemplary embodiments;

FIG. 4 depicts a computer screen window including a main menu listing options available for implementing the lesson management activities in exemplary embodiments;

FIG. 5 depicts a computer screen window including an entry form for submitting a lesson and initiating the lesson management activities in exemplary embodiments;

FIG. 6 depicts a computer screen window including a routing form for processing a submitted lesson and associated record in exemplary embodiments; and

FIG. 7 depicts a computer screen window including search options available for implementing the lesson management activities in exemplary embodiments.

The detailed description explains the preferred embodiments of the invention, together with advantages and features, by way of example with reference to the drawings.

### DETAILED DESCRIPTION OF THE INVENTION

A lessons learned knowledge management system (also referred to herein as “lesson management”) is provided in exemplary embodiments. The lessons learned knowledge management system enables users to capture and manage lessons learned as a result of a project, recall these lessons, and improve business productivity by avoiding previously learned problem areas. A lesson learned may be defined as the knowledge acquired in response to implementation and subsequent analysis of a project. As individuals associated with a project discover or learn useful information, the information is presented to the lessons learned knowledge management system, which is configured to take one or more actions on the information including, e.g., formalizing the structure and presentation of the information, searching a lessons learned database for duplicate information (and if a similar lesson/information is found, providing the ability to annotate or update the existing lesson in the lessons learned database, if applicable, to reflect the new information), initiating a workflow and routing plan for the lesson/information whereby one or more subject matter experts review, process, and ultimately accept or reject the lesson/information, which results in either archiving the lesson/information in the lessons learned database for future reference, re-routing the lesson/information to another entity for additional processing, or delegating the subject matter expert's authority to act on the lesson/information to another entity. These, and other advantages of the lesson management system are described further herein.

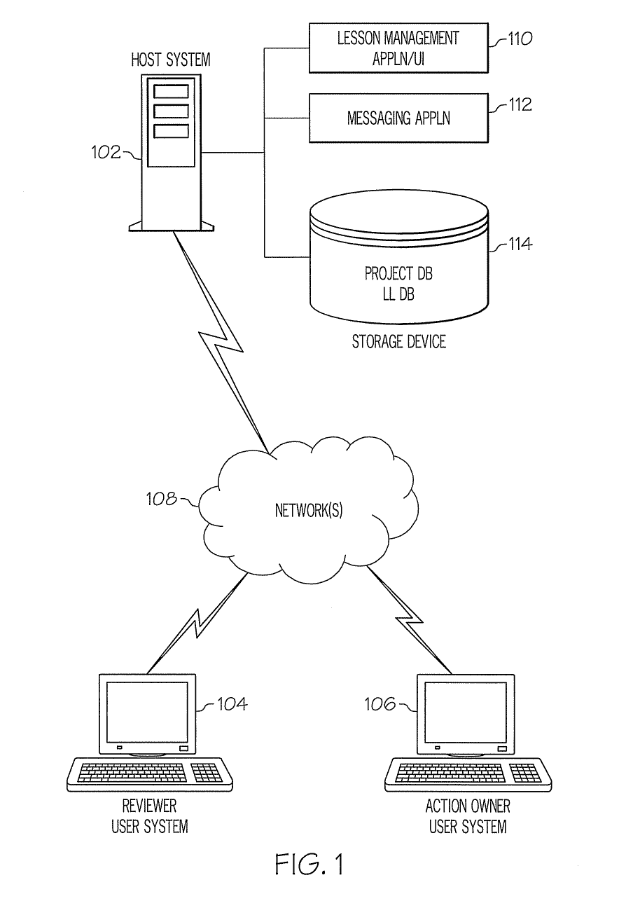

Turning now to FIG. 1, a block diagram depicting a system upon which the lesson management activities may be implemented in exemplary embodiments will now be described. The system of FIG. 1 includes a host system 102 in communication with user systems 104 and 106 over one or more network(s) 108.

In exemplary embodiments, host system 102 represents a business enterprise or similar entity that implements various projects in furtherance of its business goals. A project refers to plan that is developed and implemented in order to achieve a measurable result; that is, a temporary undertaking that ends when the objective of the project has been achieved. A project may be broken down into components, such as phases or time-based activities. A typical project may be carried out by a defined project team, whereby each of the members of the project team is tasked with one or more responsibilities. The project plan may specify a number of resources required to implement the project (e.g., tools, manpower, money, etc.). Projects may be defined by the business enterprise or by representatives acting on behalf of the business enterprise.

Host system 102 may be implemented using one or more servers operating in response to a computer program stored in a storage medium accessible by the server(s). The host system 102 may operate as a network server (e.g., a web server) to communicate with the user systems 104, 106. The host system 102 handles sending and receiving information to and from the user systems 104, 106 and can perform associated tasks. The host system 102 executes one or more applications (e.g., a lesson management application 110 including an interface component) to provide the lesson management services described herein. Host system 102 also executes a messaging application 112 (e.g., email, instant messaging, etc.) for communicating with user systems 104 and 106, as well as for processing lesson records created via the lesson management application 110 as described herein.

In exemplary embodiments, host system 102 is in communication with a storage device 114. Storage device 114 may be implemented using memory contained in the host system 102 or it may be a separate physical or virtual or logical device. In exemplary embodiments, the storage device 114 is in direct communication with the host system 102 (via, e.g., cabling). However, other network implementations may be utilized. For example, storage device 114 may be logically addressable as a consolidated data source across a distributed environment that includes one or more networks 108. Information stored in the storage device 114 may be retrieved and manipulated via the host system 102. Storage device 114 stores a variety of information for use in implementing the lesson management activities. As shown in FIG. 1, storage device 114 stores one or more project databases that describe projects of the business enterprise. The project database is created via the lesson management application 110 and is described further herein. In exemplary embodiments, storage device 114 also stores a lessons learned database that houses active, or in-process, lessons, as well as archived lessons which have been processed and accepted by via the lesson management application 110. The lessons learned database is described further herein.

User systems 104, 106 are operated by users at one or more geographic locations who may be representatives (e.g., employees) of the business enterprise operating host system 102. Optionally, one or more of the users may be members of a project team, or may be both project team members as well as reviewers/action owners. In exemplary embodiments, user system 104 refers to a reviewer user system that receives lessons learned and processes associated records pursuant to a workflow structure established via the lesson management application 110 as described herein. User system 106 refers to an action owner user system that implements one or more actions on a lesson learned as directed by a reviewer user system. These actions are also pursuant to a workflow structure constructed via the lesson management application 110. In alternative exemplary embodiments, all or a portion of the activities conducted via the user systems 104, 106 may be automated by the lesson management application 110.

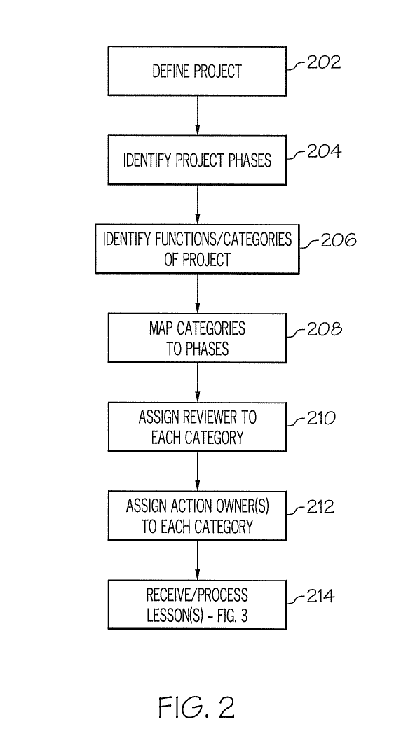

Each of user systems 104, 106 may be implemented using a general-purpose computer executing a computer program for carrying out the processes described herein. While only two user systems 104, 106 are shown in the system of FIG. 1, it will be understood that many user systems (e.g., reviewer and action owner user systems) may be implemented in order to realize the advantages of the lesson management services. In addition, an administrator user system (not shown) may be included in the system of FIG. 1. The administrator user system may be tasked with high-level responsibilities with respect to the lesson management system, such as establishing permissions for reviewers and action owners as will be described in FIG. 2. In addition, as any member of a particular project team or representative of the business enterprise may submit a lesson learned, the system of FIG. 1 may also include a submitter (also referred to as “source”) user system (not shown).

Network(s) 108 may be any type of known network including, but not limited to, a wide area network (WAN), a local area network (LAN), a global network (e.g. Internet), a virtual private network (VPN), and an intranet. The network(s) 106 may be implemented using a wireless network or any kind of physical network implementation known in the art. A user system 104, 106 may be coupled to the host system 102 through multiple networks (e.g., intranet and Internet) so that not all user systems 104, 106 are coupled to the host system 102 through the same network. One or more of the user systems 104, 106 and the host system 102 may be connected to the network 108 in a wireless fashion.

The lesson management services enable a business enterprise to construct a project database and workflow structure for handling lessons that is customizable for the particular needs of the business enterprise. In exemplary embodiments, the project database and workflow structure are implemented via the lesson management application 110 and user interface as described in FIG. 2.

Turning now to FIG. 2, a process for building a project management database and workflow structure used in implementing the lesson management activities will now be described in accordance with exemplary embodiments. As indicated above, one or more of the processes described in FIG. 2 may be performed by a high-level (e.g., administrator) of the business enterprise. At step 202, a project is defined for the business enterprise of host system 102 via the user interface of the lesson management application 110. The user interface may be implemented as a graphical user interface (GUI) that is made available by the host system 102 to network entities (e.g., 104, 106) over networks 108.

A project, for example, may be the construction of a building or the purchase and development of a parcel of real estate. The project may be identified by a short descriptive title, an alphanumeric identifier assigned to the project, or other suitable means of distinguishing the project from other projects of the business enterprise. As used herein, the terms “project” and “deal” are used interchangeably.

At step 204, project phases for the project are identified. A project phase may be defined as an ordered sequence with respect to other phases of the project and each phase specifies one or more groups of activities to be performed in furtherance of the project. For example, if the project concerns a business merger or acquisition, project phases may include identifying a candidate for merger (due diligence), pre-announcement, pre-closure, transition phase, transfer of trade, and tracking. These phases are listed in the order of execution. Each phase may require its own set of unique functions or activities.

At step 206, categories for the project are identified. Categories refer to functional areas of the business enterprise that need to be managed. For example, functional areas relating to the project example above (merger) may include accounting, communications, human resources, legal, real estate, etc. As used herein, the terms “category” and “function” are used interchangeably.

At step 208, the categories identified in step 206 are mapped, via the lesson management application 110, to corresponding phases identified in step 204 by determining activities for each phase that requirement involvement by a particular functional area or category (e.g., pre-closure activity requires the functional area or legal group to review and approve a purchase and sale agreement). Using the merger example above, it may be determined that for a given project, the accounting category should be mapped to the pre-closure and transfer of trade phases. This mapping is useful for constructing a workflow structure for processing lessons as will now be described.

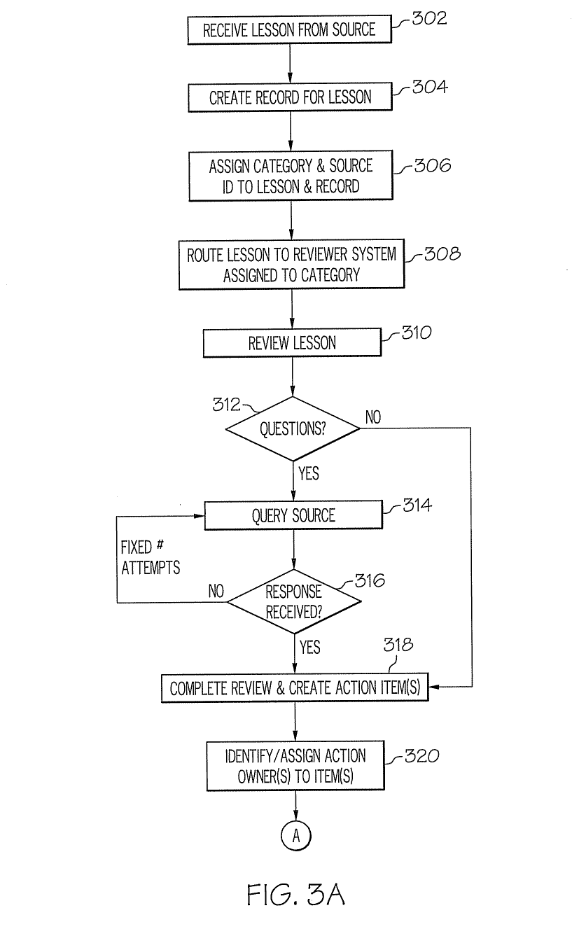

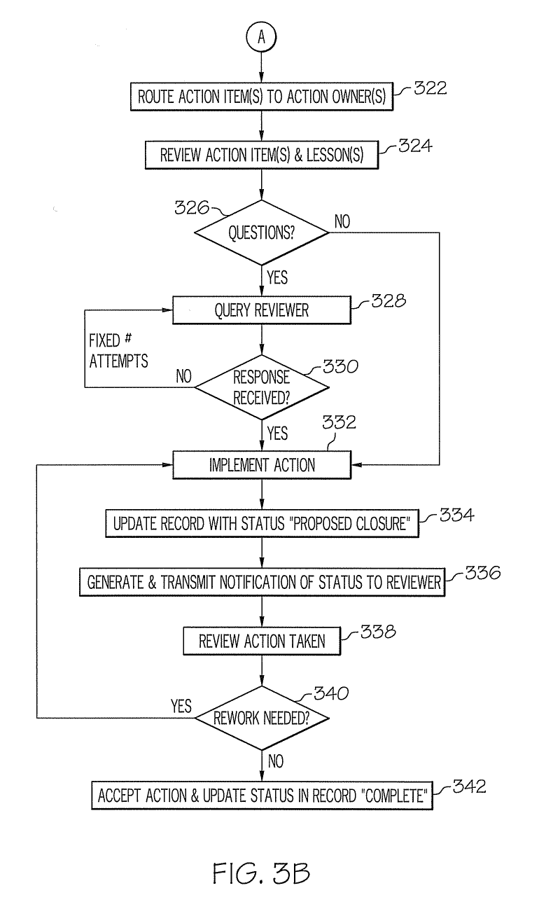

Steps 210 through 214 describe a process for creating and implementing a workflow structure for lessons learned relating to a defined project. At step 210, a reviewer is assigned to each category identified in step 206 above. In exemplary embodiments, a reviewer refers to a point-of-contact for a lesson learned that is received by the host system 102 and is based upon a category to which the lesson learned is associated. Thus, e.g., a reviewer from a legal office may be assigned to a category concerned with environmental regulations and compliance. The reviewer is charged with determining a course of action to be taken on lessons learned and supervising the actions taken by action owners throughout its processing as described further in FIG. 3.

At step 212, one or more action owners are assigned to each category within the project database. Action owners are tasked with the responsibility of taking action on the lesson learned as directed by the reviewer and as described further in FIG. 3. The lesson management application 110 includes instructions for determining which reviewer a lesson learned will be assigned, routing procedures for the transmittal of the lesson data among relevant entities (e.g., reviewer user system 104 and action owner user system 106, as well as a submitter or source user system (not shown)), and may include a time-based component for setting limits on the amount of time a lesson learned submission may be pending before a final action is taken.

The lesson management application 110 is configured such that users of the lesson management services have restricted processing capabilities with respect to lessons learned. For example, the administrator may configure the project database and workflow structure so that individuals or entities assigned to a defined role may perform certain actions with respect to a lesson. Thus, the assignment of a reviewer to a category indicates that the reviewer selected for a lesson learned has greater access and editing capabilities with respect to the lesson than that of an action owner assigned to the same lesson. A reviewer may have the capability to accept or reject a newly submitted lesson learned, while an action owner may not. In addition, each of action owners, reviewers, and lesson submitters (i.e., source) may have capabilities for submitting or editing an existing lesson. In exemplary embodiments, individuals in a reviewer role may delegate a portion of the reviewer responsibilities to another via the lesson management application 110.

The project database created from steps 202-208 and the workflow structure created via steps 210-212, in conjunction with the logic provided by the lesson management application 110, cooperatively function to implement the lessons learned management services described further in FIGS. 3-7.

Optionally, the project database may be configured to identify and distinguish one or more of geographic locations of projects, reviewers, action owners, etc. such that reviewers/action owners are assigned to categories and phases based upon a geographic region (e.g., a region in close proximity to one or more of the project, reviewer, action owner, etc.).

At step 214, each lesson learned that is received at the host system 102 is processed via the lesson management application 110, project database and workflow structure, and user systems 104, 106. A lesson learned may be submitted by a member of the project team for a project to which the lesson learned is related, or by any member of the host system enterprise if desired. A searchable lesson learned database is created for archiving these lessons and may be stored in storage device 114 of FIG. 1.

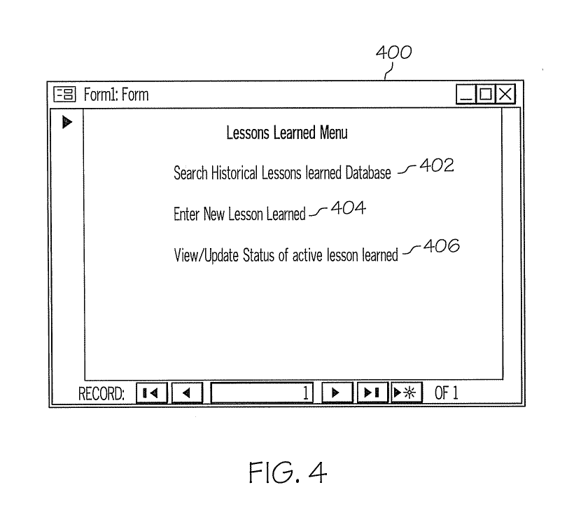

Turning now to FIG. 3A, a process for implementing the lesson management services will now be described in accordance with exemplary embodiments. At step 302, a lesson learned (also referred to herein as “lesson”) is submitted by a source and received at the host system 102. As indicated above, the source may be a member of the project team or may be any representative of the host system enterprise. The lesson management application 110 may include a user interface for submitting lessons. In exemplary embodiments, the user interface includes a main menu screen for submitting lessons, as well as for performing other related tasks. A sample user interface screen 400, provided by the lesson management application 110, illustrating a main menu is shown in FIG. 4. As shown in FIG. 4, the source selects “Enter New Lesson Learned” option 404 for entering a new lesson.

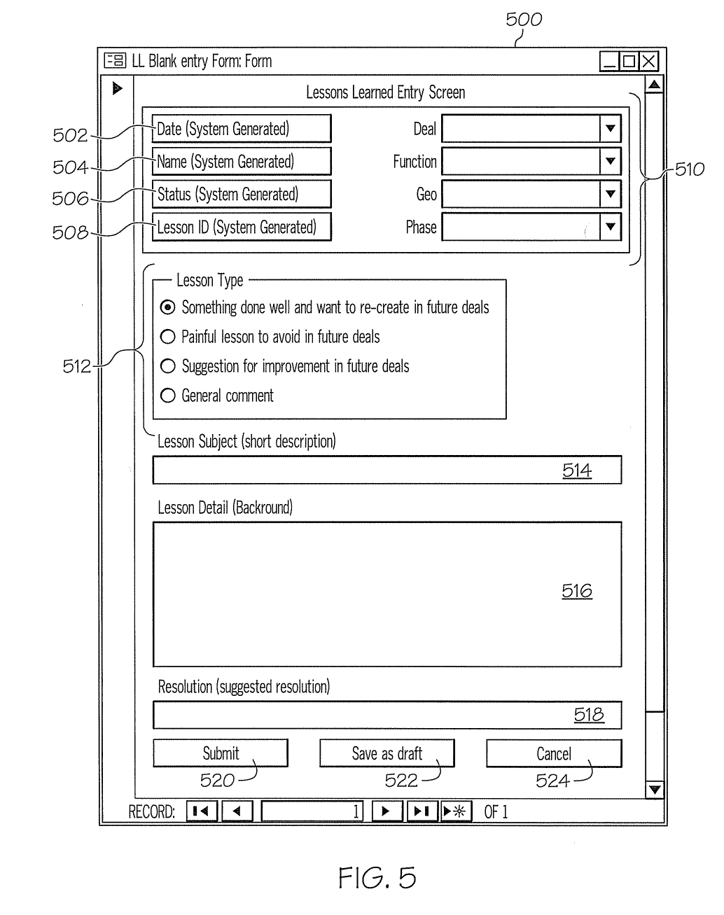

Upon selecting this option 404, the lesson management application 110 provides a user interface screen for use in entering the lesson data. A sample user interface screen 500 (entry screen) is shown in FIG. 5. The lesson management application 110 creates a record for the lesson at step 304, and generates lesson data for the record as shown in fields 502-508 of user interface screen 500. System-generated information includes, e.g., the date of lesson submission by the source in field 502, the name or source identifier of the person submitting the lesson in field 504, the current status of the lesson in field 506, and a lesson identifier in field 508. The status identifiers assist the lesson management application 110 and workflow structure in determining the routing plan for a lesson. Status identifiers available for assignment by the lesson management application 110 include, e.g., assigned, pending action, rejected, closed, and action submitted. These status identifiers are described further herein.

The user is prompted to enter or select the project (deal) to which the lesson is associated, as well as the category (function), and phase via fields 510 of user interface screen 500. Optionally, the source may enter a geography via fields 510. The geography refers to the geographical location of the project (and may also refer to the location of the source). These items (e.g., deal, function, phase, geography) are pre-configured via the processes described above in FIG. 2.

At step 306, the lesson management application 110 assigns the category and source identifier (i.e., data field 504) to the record generated in step 304. The source is also prompted to select a lesson type. Some examples of lesson types 512 are shown in user interface screen 500. Lesson types may be pre-configured by a member of the business enterprise via the lesson management application 110 or may be selected as a default. Lesson types refer to the nature of the lesson learned in terms of future actions to be taken. For example, a lesson learned may relate to an action or situation that should be avoided in the future or may involve an action that resulted in a positive experience and should be repeated. Other information that may be entered by the source includes a short description of the lesson (in box 514), specific details about the lesson (in box 516), and a suggested resolution for the lesson (in box 518).

Once completed, the source may submit the lesson by selecting option 520, save the lesson as a draft by selecting option 522, or cancel the submission by selecting option 524. Saving the lesson as a draft will prevent routing of the lesson to another entity.

Once submitted, the lesson management application 110 updates the lesson record to reflect the submission via the status identifier field 506 of user interface screen 500. The initial submission of the lesson results in a status identifier “action submitted.” In exemplary embodiments, the lesson management application 110 searches the lessons learned database for similar lessons. If found, the lesson management application 110 may display a list that matches, e.g., the deal and geography entered by the source and may further include a ‘loose’ match on the short description or title entered in box 514. The source may then pick a lesson from this list to add a comment to the existing lesson. If the source determines that the lesson submitted is unique, the source may then continue with the submission.

Once submitted, the lesson data is routed to the assigned reviewer (e.g., reviewer user system 104) based upon the category information entered (e.g., function information in fields 510), and optionally, the geography information entered in fields 510 at step 308. This information is pre-configured via the processing described above in FIG. 2. The lesson data may be routed to the reviewer via messaging application 112, whereby the workflow structure and assignments include communication information for each of the reviewer user systems and action owner user systems as needed. For example, the messaging application 112 creates an email, enters the reviewer contact information (e.g., email address) and may provide a link to the lesson record created in step 304 in the lessons learned database. In addition, this lesson record may be accessed, e.g., via the main menu of user interface screen 400 of FIG. 4 by selecting the “View/Update Status of active lesson learned” option 406.

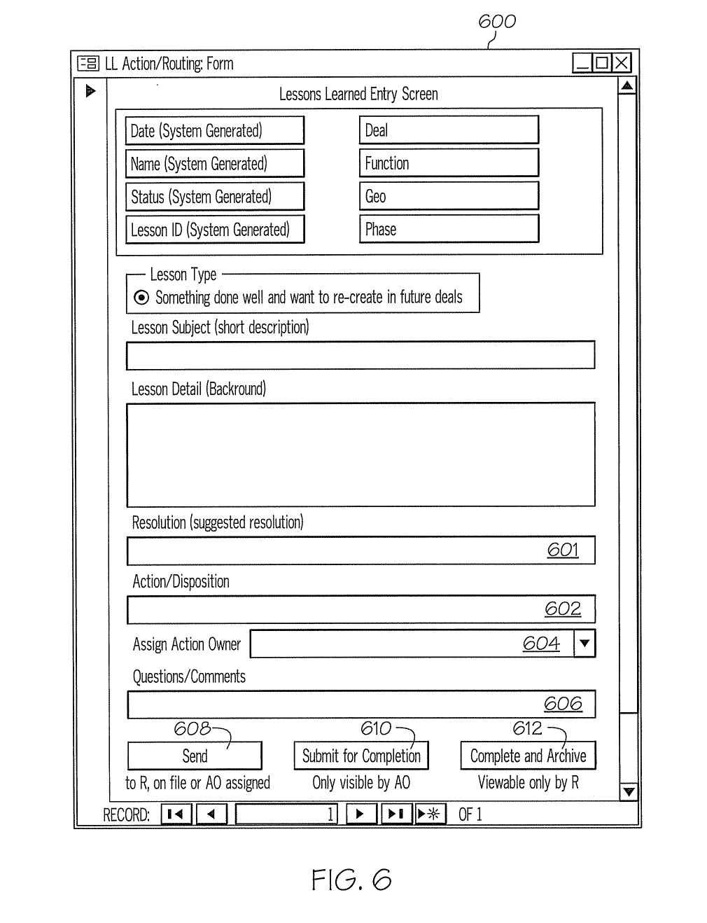

The reviewer receives the lesson data routed from the source and reviews the information contained therein at step 310, a sample of which is shown in user interface screen 600 of FIG. 6. The reviewer determines whether sufficient information is present in the lesson data in order to make a determination of whether to accept or reject the lesson at step 312. If there is not enough information present in the lesson data submitted by the source, the reviewer enters a query in box 606 of user interface screen 600, selects the source as the action owner via field 604, followed by selecting the send option 608. The lesson data is routed back to the source via messaging application 112 at step 314. The workflow structure defined by the lesson management application 110 may be configured to track the number of unsuccessful attempts (step 316) to contact the source for this information and continue to prompt the source for this information (e.g., a fixed number of times) before timing out. If a response is not received after a fixed number of unsuccessful attempts, then the lesson record may be deleted from the system. Alternatively, the workflow structure may be configured to include a “resolve by” date which is tracked by the workflow structure as the lesson is routed among assigned entities (e.g., reviewer user system 104, action owner user system 106, or the submitter (not shown)). If a response is received at step 316, the reviewer completes the review and performs one or more actions on the lesson. Actions may include rejecting the lesson, accepting and closing the lesson, or accepting the lesson and assigning an action owner. If the lesson is rejected, this means it will not be archived in the lessons learned database (i.e., will not be available for public view). Rejecting the lesson causes the lesson management application 110 to change the status identifier field 506 to “rejected.” Once a lesson is rejected, a notification is generated and transmitted to the submitter via the lesson management application 110, messaging application 112, and workflow structure working in cooperation.

Accepting and closing the lesson means that the lesson is saved without assigning an action owner. The lesson management application 110 updates the status identifier field 506 to “pending action.” The lesson will then be available for review by entities of the business enterprise. In addition, the reviewer may at any time access the lesson to edit, view, or assign an action owner. As indicated above, the reviewer may also accept and assign an action owner. If this option is selected, the lesson management application 110 updates the status identifier field 506 to “assigned” and directs the lesson to be routed to the assigned action owner. Once a lesson has been accepted, the reviewer may further select “close” which results in the archival of the lesson in the lessons learned database.

At step 318, one or more action items for the lesson are entered. The action items are entered in box 602. At step 320, the reviewer assigns an action owner to the lesson via field 604 and selects the send option 608. The process continues in FIG. 3B.

At step 322, the action items are routed to the action owner via the messaging application 112. The action owner reviews the action items at step 324.

If the action owner has any questions concerning the instructions provided by the reviewer at step 326, the action owner enters these questions in box 606, selects the reviewer from field 604, and selects the send option 608. Suppose, e.g., the deal relates to a merger integration project and that the reviewer has assigned an action item to a tax expert, such as ‘provide the local tax form numbers required for filing.’ The action owner may respond with ‘filing local tax forms is not required. Do you want the required Federal tax form numbers or more details on local tax laws?’ The workflow structure defined by the lesson management application 110 may be configured to track the number of unsuccessful attempts (step 330) to contact the reviewer for this information and continue to prompt the reviewer for this information (e.g., a fixed number of times) before timing out. If a response is not received after a fixed number of unsuccessful attempts, then the lesson record may be returned to the action owner. Otherwise, if a response is received at step 330, the action owner implements the action identified in the lesson data at step 332.

The action owner may enter “proposed closure” at step 334 via, e.g., box 518 of FIG. 5 or boxes 601 or 602 of FIG. 6, and the record is updated to reflect the status. At step 336, the lesson management application 110 generates a notification of this status and transmits the notification via the messaging application 112 to the reviewer. The reviewer, in turn, reviews the action taken by the action owner at step 338 and determines whether it is satisfactory or whether rework is needed at step 340. If rework is required, the process returns to step 332 whereby corrective or supplemental action is taken. Otherwise, the reviewer accepts the action and updates the status of the record as “complete” at step 342.

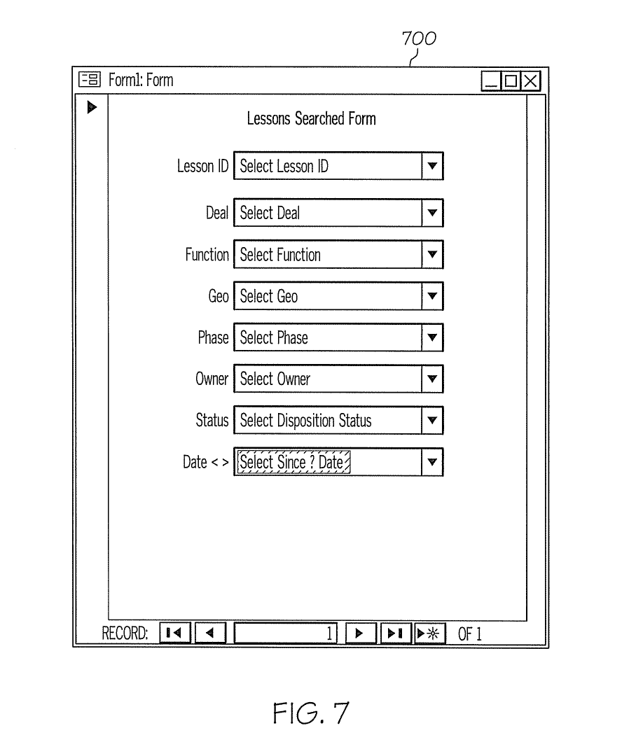

As indicated above, the approved lessons are stored in a searchable database. The lesson management application 110 includes a user interface for enabling users to search for lessons as needed. A sample user interface screen 700 is shown in FIG. 7. This user interface screen 700 may be accessed by selecting “Search historical lessons learned database” option 402 of the main menu of user interface screen 400 in FIG. 4. The user interface screen 700 illustrates various fields in which a user may search for a lesson. In this manner, lessons that have been identified, processed, and archived may be searched and reviewed by members of the business enterprise so that these lessons will not need to be re-learned in the future.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A computer-implemented method of implementing a lessons learned knowledge management system, comprising:
building a project database, including:
identifying project phases for a project, each of the project phases defined as an ordered sequence with respect to others of the project phases and specifying groups of activities to be performed in furtherance of the project;
identifying categories for the project, each of the categories defined by a functional area relating to the project and specifying groups of activities to be performed in furtherance of the project; and
mapping activities specified in the project phases to corresponding activities provided by a functional area;
generating a workflow structure for the project, comprising:
assigning a reviewer to each of the categories, the reviewer comprising a point-of-contact for a lesson learned relating to respective categories of the project;
assigning an action owner to each of the categories, the action owner tasked with taking action on the lesson learned; and
defining a routing plan and timeline for transmittal of the lesson learned between the reviewer and the action owner; and
processing lessons learned received for the project via the project database and the workflow structure.

2. The computer-implemented method of claim 1, further comprising:
creating a searchable database and storing processed lessons learned in the searchable database.

3. The computer-implemented method of claim 1, wherein the processing includes:
creating a record for each of the lessons learned;
assigning one of the categories to each of the records;
routing each of the records to a respective reviewer assigned to corresponding categories, the routing location based upon the workflow structure;
creating an action to be performed for the record and entering the action into the record;
forwarding the record including the action to a respective action owner based upon the workflow structure, the respective action owner tasked with implementing the action; and
documenting results of the action implemented by the action owner in the record.

4. The computer-implemented method of claim 3, wherein the processing further includes:
assigning a source identifier to each of the records, the source identifier identifying a user that submits a lesson learned; and
routing the record between the reviewer and the user, via the source identifier, when the reviewer determines that the lesson learned is incomplete as submitted; wherein the routing plan is updated to reflect the routing between the reviewer and the user.

5. The computer-implemented method of claim 3, wherein the processing lessons learned received for the project via the project database and the workflow structure include assigning a status identifier to the record specifying a current status of the lesson learned, the status identifier including at least one of:
assigned;
pending action;
rejected;
closed; and
action submitted.

6. The computer-implemented method of claim 1, wherein the lesson learned is categorized by type, the type including at least one of:
at least one of an action and a situation to be avoided in the future; and
an action resulting in a positive experience to be repeated.

7. The computer-implemented method of claim 1, wherein the building a project database further comprises:
identifying a geographical location within which the project is performed;
mapping the categories and respective phases of the project to the geographical location; and
wherein the generating a workflow structure for the project includes assigning a reviewer and action owner to each of the categories based upon geographical location of the project, the reviewer, and the action owner.

8. A system for implementing a lessons learned knowledge management system, comprising:
a host system; and
a lesson management application executing on the host system, the lesson management application including an interface component, wherein the lesson management application implements a method via the interface component, comprising:
building a project database, including:
identifying project phases for a project, each of the project phases defined as an ordered sequence with respect to others of the project phases and specifying groups of activities to be performed in furtherance of the project;
identifying categories for the project, each of the categories defined by a functional area relating to the project and specifying groups of activities to be performed in furtherance of the project; and
mapping activities specified in the project phases to corresponding activities provided by a functional area;
generating a workflow structure for the project, comprising:
assigning a reviewer to each of the categories, the reviewer comprising a point-of-contact for a lesson learned relating to respective categories of the project;
assigning an action owner to each of the categories, the action owner tasked with taking action on the lesson learned; and
defining a routing plan and timeline for transmittal of the lesson learned between the reviewer and the action owner; and
processing lessons learned received for the project via the project database and the workflow structure.

9. The system of claim 8, wherein the lesson management application further performs:
creating a searchable database and storing processed lessons learned in the searchable database.

10. The system of claim 8, wherein the processing includes:
creating a record for each of the lessons learned;
assigning one of the categories to each of the records;
routing each of the records to a respective reviewer assigned to corresponding categories, the routing location based upon the workflow structure;
creating an action to be performed for the record and entering the action into the record;
forwarding the record including the action to a respective action owner based upon the workflow structure, the respective action owner tasked with implementing the action; and
documenting results of the action implemented by the action owner in the record.

11. The system of claim 10, wherein the processing further includes:
assigning a source identifier to each of the records, the source identifier identifying a user that submits a lesson learned; and
routing the record between the reviewer and the user, via the source identifier, when the reviewer determines that the lesson learned is incomplete as submitted; wherein the routing plan is updated to reflect the routing between the reviewer and the user.

12. The system of claim 10, wherein the processing lessons learned received for the project via the project database and the workflow structure include assigning a status identifier to the record specifying a current status of the lesson learned, the status identifier including at least one of:
assigned;
pending action;
rejected;
closed; and
action submitted.

13. The system of claim 8, wherein the lesson learned is categorized by type, the type including at least one of:
at least one of an action and a situation to be avoided in the future; and
an action resulting in a positive experience to be repeated.

14. The system of claim 8, wherein the building a project database further comprises:
identifying a geographical location within which the project is performed;
mapping the categories and respective phases of the project to the geographical location; and
wherein the generating a workflow structure for the project includes assigning a reviewer and action owner to each of the categories based upon geographical location of the project, the reviewer, and the action owner.

15. A computer program product for implementing a lessons learned knowledge management system, the computer program product including instructions for causing a computer to implement a method, comprising:
building a project database, including:
identifying project phases for a project, each of the project phases defined as an ordered sequence with respect to others of the project phases and specifying groups of activities to be performed in furtherance of the project;
identifying categories for the project, each of the categories defined by a functional area relating to the project and specifying groups of activities to be performed in furtherance of the project; and
mapping activities specified in the project phases to corresponding activities provided by a functional area;
generating a workflow structure for the project, comprising:
assigning a reviewer to each of the categories, the reviewer comprising a point-of-contact for a lesson learned relating to respective categories of the project;
assigning an action owner to each of the categories, the action owner tasked with taking action on the lesson learned; and
defining a routing plan and timeline for transmittal of the lesson learned between the reviewer and the action owner; and
processing lessons learned received for the project via the project database and the workflow structure.

16. The computer program product of claim 15, further comprising instructions for implementing:
creating a searchable database and storing processed lessons learned in the searchable database.

17. The computer program product of claim 15, wherein the processing includes:
creating a record for each of the lessons learned;
assigning one of the categories to each of the records;
routing each of the records to a respective reviewer assigned to corresponding categories, the routing location based upon the workflow structure;
creating an action to be performed for the record and entering the action into the record;
forwarding the record including the action to a respective action owner based upon the workflow structure, the respective action owner tasked with implementing the action;
documenting results of the action implemented by the action owner in the record.
assigning a source identifier to each of the records, the source identifier identifying a user that submits a lesson learned; and
routing the record between the reviewer and the user, via the source identifier, when the reviewer determines that the lesson learned is incomplete as submitted; wherein the routing plan is updated to reflect the routing between the reviewer and the user.

18. The computer program product of claim 17, wherein the processing lessons learned received for the project via the project database and the workflow structure include assigning a status identifier to the record specifying a current status of the lesson learned, the status identifier including at least one of:
assigned;
pending action;
rejected;
closed; and
action submitted.

19. The computer program product of claim 15, wherein the lesson learned is categorized by type, the type including at least one of:
at least one of an action and a situation to be avoided in the future; and
an action resulting in a positive experience to be repeated.

20. The computer program product of claim 15, wherein the building a project database further comprises:
identifying a geographical location within which the project is performed;
mapping the categories and respective phases of the project to the geographical location; and
wherein the generating a workflow structure for the project includes assigning a reviewer and action owner to each of the categories based upon geographical location of the project, the reviewer, and the action owner.
